(19) United States
(12) Patent Application Publication
(10) Pub. No.: US 2018/0246916 A1
(43) Pub. Date: Aug. 30, 2018

(54) SCALABLE OBJECT SERVICE DATA AND METADATA OVERFLOW

(71) Applicant: Microsoft Technology Licensing, LLC, Redmond, WA (US)

(72) Inventors: Diaa FATHALLA, Redmond, WA (US); Ali Ediz TURKOGLU, Sammamish, WA (US)

(21) Appl. No.: 15/461,521

(22) Filed: Mar. 17, 2017

Related U.S. Application Data
(60) Provisional application No. 62/463,663, filed on Feb. 26, 2017.

(51) Int. Cl. G06F 17/30

(52) U.S. Cl. CPC G06F 17/30318; G06F 17/30917; G06F 17/303

(57) ABSTRACT

Technologies support virtual expansion of object containers and of individual large objects in a cluster. Some examples provide scalable object service blob container overflow using multiple clustered shared volumes. One or more of the following may overflow from one cluster volume to another: multiple individual data objects of a container, at least one section of a data object of the container, metadata of at least one object of the container, system metadata of the container. The overflow may be hidden by maintaining a flat namespace outside the cluster.

### BACKGROUND

An object service in a cloud or other distributed digital environment provides an application program interface (“API”) or other interface through which callers can create and access objects. The objects are stored in digital storage devices, and are managed through the service by execution of computational instructions. The objects may be all of a given type, e.g., they may each be a binary large object (“blob”), or the objects may be of various types.

### SUMMARY

Some technologies described herein are directed to the technical activity of managing storage space in a distributed computing environment. Some are directed in particular to managing storage space by overflowing data of an object, metadata of an object, or both, from a given file system or storage volume to other file systems or storage volumes. Some are directed at maintaining a flat namespace even though such overflow occurs. Other technical activities pertinent to teachings herein will also become apparent to those of skill in the art.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory which interact with one another under the control of software, and also illustrating some configured storage medium examples;

FIG. 2 is a block diagram illustrating aspects of a cluster;

FIG. 3 is a diagram illustrating aspects of an overflow example with object data of a given object container stored on multiple volumes in a cluster;

FIG. 4 is a diagram illustrating aspects of a namespace mapping data structure used with overflow beyond a single storage volume;

FIG. 5 is a diagram illustrating aspects of an overflow example with object metadata stored on multiple volumes in a cluster;

FIG. 6 is a diagram illustrating aspects of an overflow example with data of a given large object stored on multiple volumes in a cluster; and

FIG. 7 is a flow chart illustrating aspects of some process and configured storage medium examples.

### DETAILED DESCRIPTION

Overview

Assume a highly scalable object service that exposes a uniform namespace for objects created, and assume the service maps containers of such objects to a cluster and in particular to the cluster's set of cluster shared volumes or other storage resource(s). Also assume that the service designates and distributes original placement of containers based on properties of the cluster and clustered shared volumes, such as current free space, and that the service has no practical way to determine beforehand how many objects a client will allocate. Then the service faces a denial-of-storage problem if too many hot (i.e., in use) containers are allocated in a single cluster shared volume or other physical storage resource when no more space could be accommodated. This may occur even though space is available elsewhere in the cluster. That is, when an object service maps a uniform namespace for a container of objects to an underlying file system implementation, such as on a failover cluster with cluster shared volumes, it faces a problem when a single volume that holds a set of containers would run out of storage space, in that the caller to the service will be unable to create or enlarge an object as desired, due to the lack of storage space.

To be as highly scalable as desired, an object service implementation may be required to scale when there is sufficient space available in cluster as a whole even though sufficient space is not available on the volume in question. Innovations described herein address such problems by providing tools and techniques to overflow the data, or metadata, or both, of such containers, thereby safely overflowing one or more volumes within the same cluster. Data and metadata which is not overflowed remains in place. Overflow corresponds in result to movement, not to copying, although in some examples overflow can be implemented with a copy from X to Y followed by a deletion from X.

In some examples, a highly scalable object service implementation exposes a uniform namespace for objects created, and maps containers of such objects to a cluster and its set of cluster shared volumes (which are also called “cluster volumes”). The objects can be any storage objects, such as cloud pages, blocks, chunks, or blobs, to name just a few of the many possibilities. In some cases, objects can themselves be containers of other objects. Some tools and techniques overflow the data of such containers to more than one cluster shared volume while keeping the associated metadata of such containers in the same cluster shared volume. Some tools and techniques overflow the metadata of such object containers. Some tools and techniques permit an object itself to be broken into sections to overflow the object's data over multiple cluster shared volumes.

Some embodiments described herein may be viewed in a broader context. For instance, concepts such as availability, cluster, object, overflow, and storage volume may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and methods involving availability, cluster, object, overflow, or storage volume are outside the present scope. Accordingly, vagueness, mere abstractness, lack of technical character, and accompanying proof problems are also avoided under a proper understanding of the present disclosure.

The technical character of embodiments described herein will be apparent to one of ordinary skill in the art, and will also be apparent in several ways to a wide range of attentive readers. First, some embodiments address technical activities that are rooted in cloud computing technology, such as allocating scarce storage resources and determining when storage resources are available and what data structure modifications are appropriate to support their allocation for use. Second, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein monitor particular storage conditions such as the size of storage available on various volumes in a cluster or other collection of storage volumes in a cloud or other distributed system. Third, technical effects provided by some embodiments include efficient allocation of storage for data and metadata of objects in a cloud transparently to callers of an object service, and reduction or avoidance of messages to callers indicating that storage is not available. Fourth, some embodiments include technical adaptations such as a metastore (e.g., metadata database) that keeps track of where each object is located for a given container in a cluster shared volume, a namespace mapping between container objects and storage partitions, blob records, partition records, and data section records. Fifth, some embodiments modify technical functionality of a cloud computing environment or other distributed system by adding an overflow manager which controls object service data and metadata overflow. Sixth, technical advantages of some embodiments include improved efficiency in the use of digital storage space, expansion of the size of an individual blob or other object that can be stored in a given cluster, and expansion of the circumstances in which a uniform flat namespace such as a uniform resource locator (“URL”) namespace can be used. Other advantages will also be apparent to one of skill from the description provided.

### ACRONYMS AND ABBREVIATIONS

Some acronyms and abbreviations are defined below. Others may be defined elsewhere herein or require no definition to be understood by one of skill.

ALU: arithmetic and logic unit

API: application program interface

APP: application

CD: compact disc

CPU: central processing unit

CSV: cluster shared volume, a.k.a. clustered shared volume, cluster volume

DVD: digital versatile disk or digital video disc

FPGA: field-programmable gate array

FPU: floating point processing unit

GPU: graphical processing unit

GUI: graphical user interface

IDE: integrated development environment, sometimes also called “interactive development environment”

MPI: message passing interface

OS: operating system

RAM: random access memory

ROM: read only memory

URL: uniform resource locator

### Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, smartphones, smartwatches, smartbands, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on server computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

A “virtual machine” is an emulation of a real or hypothetical physical computer system. Each virtual machine is backed by actual physical computing hardware (e.g., processor and memory) and can support execution of at least one operating system or other kernel.

“Code” means processor instructions, data (which includes constants, variables, and data structures), or both instructions and data. “Code” and “software” are used interchangeably herein. Executable code, interpreted code, and firmware are some examples of code.

“Object” means a digital artifact which has content that consumes storage space in a digital storage device. An object has at least one access method providing access to digital content of the object.

“Blob” means binary large object. The data in a given blob may represent anything: video, audio, and executable code are familiar examples of blob content, but other content may also be stored in blobs

“Capacity” means use or control of one or more computational resources. Storage resources, network resources, and compute resources are examples of computational resources.

“Optimize” means to improve, not necessarily to perfect. For example, it may be possible to make further improvements in a program or an algorithm which has been optimized.

“Program” is used broadly herein, to include applications, kernels, drivers, interrupt handlers, firmware, state machines, libraries, and other code written by programmers (who are also referred to as developers) and/or automatically generated.

“Routine” means a function, a procedure, an exception handler, an interrupt handler, or another block of instructions which receives control via a jump and a context save. A context save pushes a return address on a stack or otherwise saves the return address, and may also save register contents to be restored upon return from the routine.

“Service” means a program in a cloud computing environment or another distributed system. A “distributed system” is a system of two or more physically separate digital computing systems operationally connected by one or more networks.

“IoT” or “Internet of Things” means any networked collection of addressable embedded computing nodes. Such nodes are examples of computer systems as defined herein, but they also have at least two of the following characteristics: (a) no local human-readable display; (b) no local keyboard; (c) the primary source of input is sensors that track sources of non-linguistic data; (d) no local rotational disk storage—RAM chips or ROM chips provide the only local memory; (e) no CD or DVD drive; (f) embedment in a household appliance; (g) embedment in an implanted medical device; (h) embedment in a vehicle; (i) embedment in a process automation control system; or (j) a design focused on one of the following: environmental monitoring, civic infrastructure monitoring, industrial equipment monitoring, energy usage monitoring, human or animal health monitoring, or physical transportation system monitoring.

A “hypervisor” is a software platform that runs virtual machines. Some examples include Xen® (mark of Citrix Systems, Inc.), Hyper-V® (mark of Microsoft Corporation), and KVM (Kernel-based Virtual Machine) software.

With regard to computational resources, the terms “assign”, “reassign”, “allocate”, and “reallocate” are used interchangeably herein.

As used herein, “include” allows additional elements (i.e., includes means comprises) unless otherwise stated. “Consists of” means consists essentially of, or consists entirely of. X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Operations such as transmitting storage capacity assignment commands, identifying storage capacity availability gaps, and approving and performing storage capacity reassignments, are understood herein as requiring and providing speed and accuracy that are not obtainable by human mental steps, in addition to their inherently digital nature. This is understood by persons of skill in the art but others may sometimes need to be informed or reminded of that fact.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Linguistically” means by using a natural language or another form of communication which is often employed in face-to-face human-to-human communication. Communicating linguistically includes, for example, speaking, typing, or gesturing with one's fingers, hands, face, and/or body.

Throughout this document, use of the optional plural “(s)”, “(es)”, or “(ies)” means that one or more of the indicated feature is present. For example, “processor(s)” means “one or more processors” or equivalently “at least one processor”.

For the purposes of United States law and practice, at least, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, at least, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest with regard to a destination or other subject may involve intervening action by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave outside the scope of patentable subject matter under United States Patent and Trademark Office (USPTO) interpretation of the In re Nuijten case. No claim covers a signal per se in the United States, and any claim interpretation that asserts otherwise is unreasonable on its face. Unless expressly stated otherwise in a claim granted outside the United States, a claim does not cover a signal per se.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

Note Regarding Hyperlinks

Portions of this disclosure may be interpreted as containing URLs, hyperlinks, paths, or other items which might be considered browser-executable codes, e.g., instances of “c:\”. These items are included in the disclosure for their own sake to help describe some embodiments, rather than being included to reference the contents of web sites or other online or cloud items that they identify. Applicants do not intend to have these URLs, hyperlinks, paths, or other such codes be active links. None of these items are intended to serve as an incorporation by reference of material that is located outside this disclosure document. The United States Patent and Trademark Office or other national patent authority will disable execution of these items if necessary when preparing this text to be loaded onto any official web or online database.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 distributed system such as a cloud computing operating environment, also referred to as a cloud or as an operating environment
102 computer system
104 users
106 peripherals
108 network
110 processor
112 computer-readable storage medium, e.g., RAM, hard disks
114 removable configured computer-readable storage medium
116 instructions executable with processor
118 data
120 application software (“software” may include firmware)
122 kernel software
124 services, e.g., authentication service, health monitoring service, object service; an object storage service is an example of an object service
126 software code implementing a service
128 data used in implementing a service, or data managed by a service
130 hardware in addition to processor and memory hardware
200 cluster of computational systems (may include storage devices, processing nodes, or both, for example)
202 node of a cluster
204 resource of a cluster (may be in a node or separate but associated with one or more nodes)
206 compute resource, namely, resource used primarily to perform digital computation
208 storage resource, namely, resource used primarily to store digital data for possible later retrieval
210 shared volume for digital storage
212 object service
214 file system
216 partition
218 object container
220 object
222 metadata, e.g., object identifier, properties, storage location, section identifiers and locations, partition which holds an object, access permissions, and so on; in addition to such system metadata, metadata in a given implementation may include metadata defined by a customer (e.g., end-user, client) such as photo GPS location, names of people in photo object, object author, other tags, and so on.
224 monitoring agent
226 metadata manager
228 transactional database of metadata, a.k.a. metastore
230 overflow info, e.g., designation of volume(s) into which embodiment will overflow data or metadata or both for one or more given overflow situations
232 partition table (in this and other tables, rows correspond to records)
234 object table, a.k.a. container object table, e.g., this table is a blob table when the objects are blobs; in some examples, each container has its own container object table
236 container table, which lists all the containers allocated in the current clustered shared volume
238 section of large object's data, also referred to as a “data section”
240 data (as opposed to metadata) of a data object
242 identifier generally
302 object record
304 partition record
306 volume, a.k.a. cluster volume
400 mapping data structure on filesystem
402 branch of mapping data structure
502 DB (metastore) record
504 object container record
602 data section record
700 flowchart
702 designate volume for use in storing container
704 allocate storage space for container
706 allocate storage space for object
708 run out of storage space
710 storage space, a.k.a., storage capacity
712 overflow data objects of a container from one volume to another volume
714 overflow data of an individual relatively large object from one volume to another volume
716 overflow metadata of objects of a container or of the container itself from one volume to another volume
718 keep data or metadata on a given volume instead of overflowing the data or metadata to another volume
720 specify an overflow threshold, e.g., minimum amount of free space left on a volume or maximum percentage of total space in use on a volume
722 overflow threshold
724 maintain metadata, e.g., by creating or updating a metadata record in a metastore database
726 identify a current or likely storage capacity deficiency
728 call a metadata manager
730 designate one or more volumes to receive overflow of data or metadata
732 keep metadata in a database
734 create a storage partition
736 discover a previously created storage partition
738 receive a notification
740 notification
742 use a storage partition
744 open a database, e.g., a metastore implementation
746 use a database, e.g., a metastore implementation
748 map from an identifier in a namespace to storage artifacts, e.g., volumes, files
750 namespace
752 storage artifacts
754 split a relatively large object into sections, e.g., an object that is too large to store on a single volume, or an object whose size is more than X times the average size of objects which are stored on a given volume, where X is specified as an overflow threshold and could be, e.g., ten or a hundred, or a thousand etc. in a given implementation
758 migrate data or metadata or both to at least partially undo previous overflow operation(s)

Operating Environments

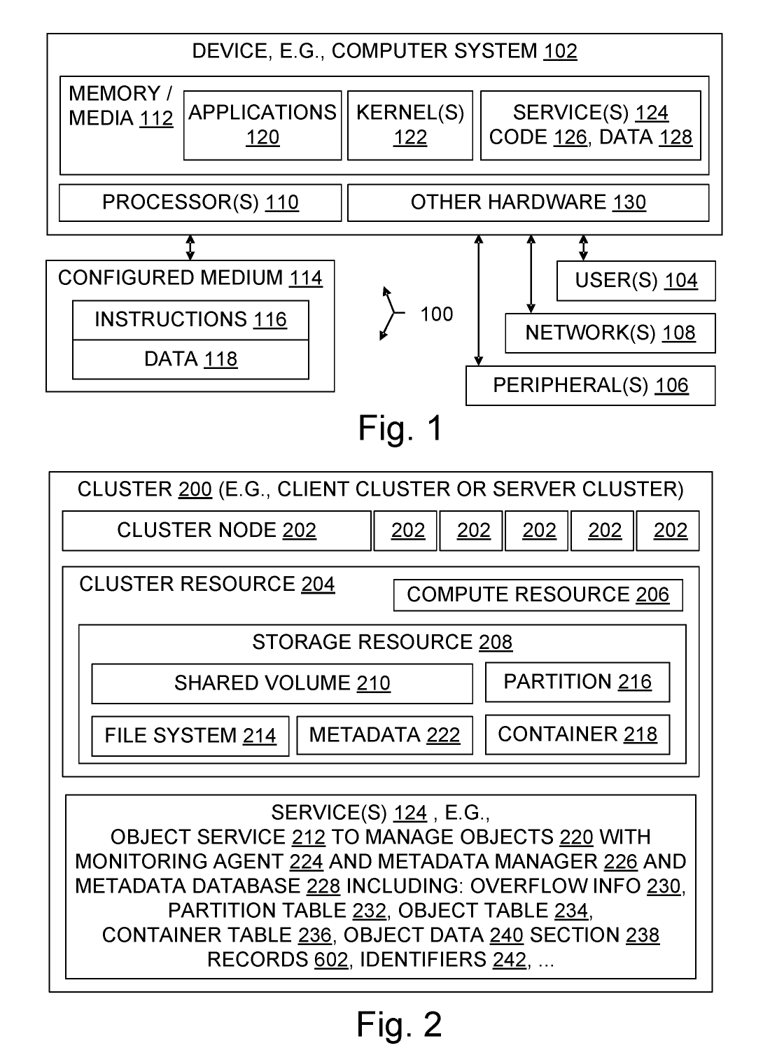

With reference to FIG. 1, an operating environment 100 for an embodiment, also referred to as a cloud 100 or distributed system 100, includes at least two computer systems 102 (one is shown). A given computer system 102 may be a multiprocessor computer system, or not. An operating environment may include one or more machines in a given computer system, which may be clustered, client-server networked, and/or peer-to-peer networked within a cloud 100. An individual machine is a computer system, and a group of cooperating machines is also a computer system. A given computer system 102 may be configured for end-users, e.g., with applications, for administrators, as a server, as a distributed processing node, and/or in other ways.

A cluster 200 includes multiple nodes 202. Each node includes one or more systems 102, such as one or more clients 102 or servers 102. A client cluster may communicate with a server cluster through a network 108. In some embodiments, network 108 may be or include the Internet, a WAN, a LAN, or any other type of network known to the art. In some embodiments, a server cluster 200 has resources 204 that are accessed by applications 120 on a client cluster 200, e.g., by applications residing on a client 102. In some embodiments, a client may establish a session with a cluster to access the resources 204 on cluster on behalf of an application residing on the client. The resources 204 may include compute resources 206, or storage resources 208, for example.

Human users 104 may interact with the computer system 102 by using displays, keyboards, and other peripherals 106, via typed text, touch, voice, movement, computer vision, gestures, and/or other forms of I/O. A user interface may support interaction between an embodiment and one or more human users. A user interface may include a command line interface, a graphical user interface (GUI), natural user interface (NUI), voice command interface, and/or other user interface (UI) presentations.

System administrators, developers, engineers, and end-users are each a particular type of user 104. Automated agents, scripts, playback software, and the like acting on behalf of one or more people may also be users 104. Storage devices and/or networking devices may be considered peripheral equipment in some embodiments and part or all of a system 102 in other embodiments. In particular, Network Attached Storage (NAS) devices, Storage Area Network (SAN) devices, devices including a redundant array of disks, and other digital storage devices may be considered peripheral equipment in some embodiments and part or all of a system 102 in other embodiments, depending on the scope of interest one has. Other computer systems not shown in FIG. 1 may interact in technological ways with the computer system 102 or with another system embodiment using one or more connections to a network 108 via network interface equipment, for example.

Each computer system 102 includes at least one logical processor 110. The computer system 102, like other suitable systems, also includes one or more computer-readable storage media 112. Media 112 may be of different physical types. The media 112 may be volatile memory, non-volatile memory, fixed in place media, removable media, magnetic media, optical media, solid-state media, and/or of other types of physical durable storage media (as opposed to merely a propagated signal). In particular, a configured medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se under any claim pending or granted in the United States.

The medium 114 is configured with binary instructions 116 that are executable by a processor 110; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (CPUs, ALUs, FPUs, and/or GPUs), memory/storage media 112, an operating environment may also include other hardware 130, such as displays, batteries, buses, power supplies, wired and wireless network interface cards, accelerators, racks, and network cables, for instance. A display may include one or more touch screens, screens responsive to input from a pen or tablet, or screens which operate solely for output. Cloud hardware such as processors, memory, and networking hardware are provided at least in part by an IaaS provider.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a technical system, such as a portion of the Internet of Things, such that no human user 104 interacts directly with the embodiment. Software processes may be users 104.

In some embodiments, the system includes multiple computers connected by a network 108. Networking interface equipment can provide access to networks 108, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches.

The one or more applications 120, one or more kernels 122, the code 126 and data 128 of services 124, and other items shown in the Figures and/or discussed in the text, may each reside partially or entirely within one or more hardware media 112, thereby configuring those media for technical effects which go beyond the “normal” (i.e., least common denominator) interactions inherent in all hardware—software cooperative operation.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

Data Overflow Tools and Techniques

Some examples herein are illustrated with regard to a cluster. As used herein, a “cluster” refers any of the following: a failover cluster system, a failover cluster, a high-availability cluster (also called an “HA cluster”), a set of loosely or tightly connected computers that work together and are viewed as a single system by a remote caller or remote client machine, a set of computers (“nodes”) controlled and scheduled by software to work together to perform the same task, a distributed computational system that provides a shared storage volume entity, a distributed system that provides a clustered shared volume that is exposed to each clustered node in the system, or a group of computers that support server applications that can be reliably utilized with a specified minimum amount of down-time. Clusters are available from many different vendors, including Microsoft, IBM, Hewlett-Packard, and others.

Some examples are illustrated by part or all of FIGS. 1 through 7. Examples are provided herein to help illustrate aspects of the technology, but the examples given within this document do not describe all of the possible embodiments. Embodiments are not limited to the specific implementations, arrangements, displays, features, approaches, or scenarios provided herein. A given embodiment may include additional or different technical features, mechanisms, sequences, or data structures, for instance, and may otherwise depart from the examples provided herein.

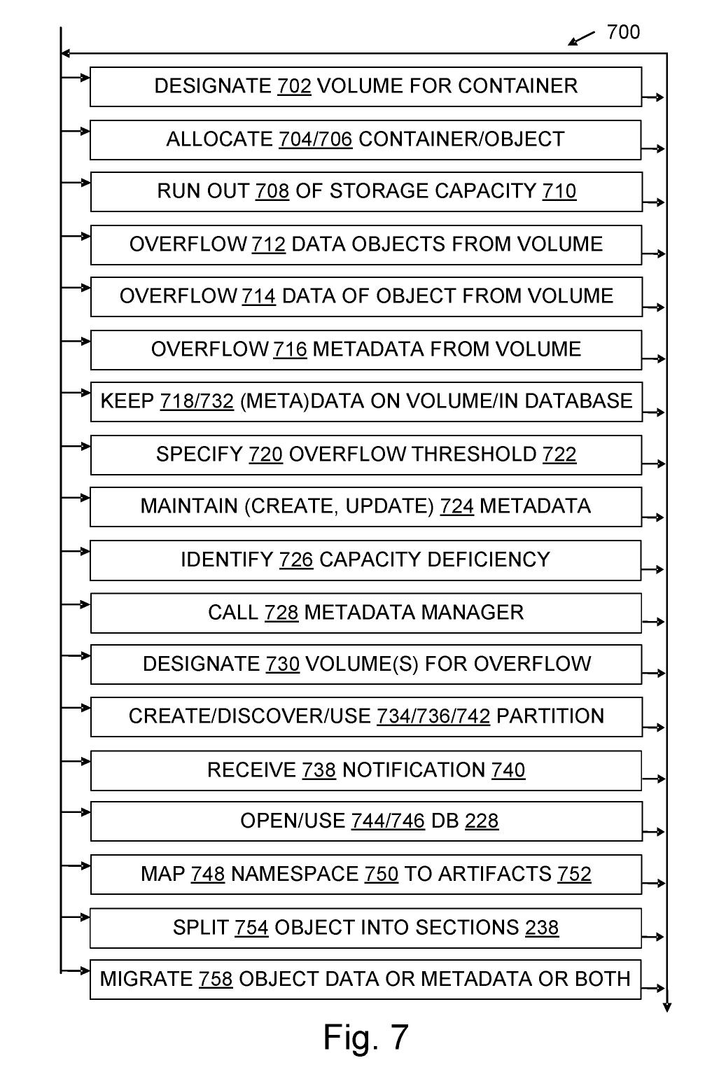

In particular, FIG. 7 illustrates some process embodiments in a flowchart 700. Technical processes shown in the Figures or otherwise disclosed will be performed automatically, e.g., by object service 212 code, unless otherwise expressly indicated. Processes may be performed in part automatically and in part manually to the extent action by a human administrator or other human person is implicated. No process contemplated as innovative herein is entirely manual. In a given embodiment zero or more illustrated steps of a process may be repeated, perhaps with different parameters or data to operate on. Steps in an embodiment may also be done in a different order than the top-to-bottom order that is laid out in FIG. 7. Steps may be performed serially, in a partially overlapping manner, or fully in parallel. The order in which flowchart 700 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

In some examples, a storage service 124 runs on a failover clustered system 200 and utilizes a set of clustered shared volumes 210 also known as CSVs. In other examples, failover support is not present. In one example architecture, a cluster 200 includes several nodes 202 with associated services and clustered file systems. In one example, a node N1 202 has a blob service BS1 (an example of an object service 212), a clustered file system FS1 214 with a partition P1 216, and a clustered file system F52; a node N2 has a blob service BS2, a clustered file system FS3 with a partition P2; a node N3 has a blob service BS3, and a node N4 has a blob service BS4. In some examples, CSVs are depicted as clustered file systems.

In one example, a scalable object storage service 212 defines a container 218, which implements a bag of storage objects 220 that are created by a client. A blob service such as in the preceding paragraph is an example of a scalable object storage service 212. Microsoft® Azure® software definitions of blob containers are one of many possible examples of containers 218 (marks of Microsoft Corporation). Although some versions of Microsoft® Azure® software are suitable for use with, or include, some or all of the innovations described herein, the innovative teachings presented herein may also be applied and implemented with distributed system or cloud services provided by other vendors. The claim coverage and description are not restricted to instances that use Microsoft products or Microsoft services. In general, a bag is an unordered set. In some examples, a minimal requirement for defining a bag of objects is that each object have a respective identifier and be subject to at least one access method. Access methods may append an object, support random access of a given object, support queries across objects, and so on, depending on the particular embodiment.

In some examples, at the creation of a container 218 the storage service 212 designates 702 one of the clustered shared volumes 210 as a destination for this container and allocates 704 the container in that designated CSV. This allocation may be based on properties of the cluster or the destination clustered shared volume, such as free space, current node CPU utilization, remaining memory, and so on. Later a client starts allocating 706 blob objects under this container. Those objects originally get created under that CSV. Eventually if the client allocates a sufficient number of objects, or sufficiently large objects, or some combination of these two factors, the CSV can run out 708 of space 710. CSVs occur in, but are not limited to, facilities using Microsoft cloud or database or file system software.

Some embodiments overflow 712 the data of containers to more than one clustered shared volume while keeping 718 the associated metadata 222 of such containers in same clustered shared volume. The file system 214 artifacts representing the objects 220 such as chunks and files will get redirected to another volume once the primary volume's available space reaches a specified high water mark 722. This threshold point 722 can be based on a customizable policy defined 720 by an administrator 104 of the distributed system. In some examples, the blob service or other object service contains a monitoring agent 224 and a volume metadata manager 226. The object service also maintains 724 a transactional database 228 containing metadata (state) information associated with containers and objects. One implementation uses an extensible storage engine (ESE/NT) database system for this purpose.

Once a volume is identified 726 by a storage monitoring agent as running out of space, the storage monitoring agent will call 728 the metadata volume manager and specify 730 the volume that the container can overflow its data into using 742 another partition. This specification is also referred to as designating 730 overflow destinations.

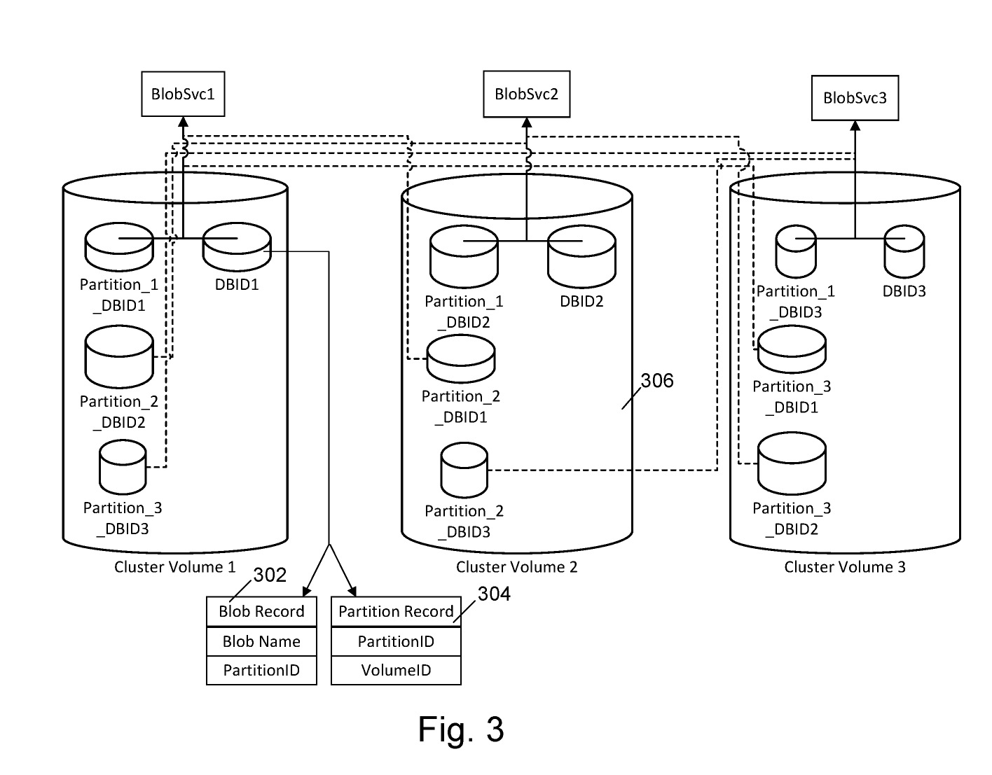

As illustrated in FIGS. 2 and 3, this overflow information 230 is persisted in the metastore (DB) in a partition table 232. Partition table 232 contains partition records 304. The metastore 228 has also another table 234 that keeps track of where each object is located for a given container in a CSV. It is called a blob table or more generally referred to as a container object table 234 (since objects are not necessarily blobs in a given embodiment). The object table 234 has an extra field that has an id that maps to the partition table field that has the destination volume id. This level of indirection is used so that the volume id can be substituted with another volume id without the need to modify the blob records (object records 302, in the general case) themselves.

In some situations, an embodiment will keep 732 the metadata for the container 218 in a designated CSV inside a transactional database table, with metadata information about a container's overflow state 230, the container's associated partitions 216 if any, and the container's associated objects 220. The object service will then automatically overflow 712 containers, by creating 734 new partitions on remote volumes in the distributed system and new objects will then allocated 706 in those remote partitions. A distinct policy layer (e.g., with agent 224 and manager 226) in the object service will real time monitor and discover clustered system properties such as I/O load, CPU load, free space in each CSV and/or clustered nodes, in order to decide 726 whether to overflow, and decide 730 where to overflow.

For example, with reference to the diagram in FIG. 3, if the destination store id is 1, then this is an indication that the blob data is on the primary partition. The primary partition is the data partition that coexists with the metastore on the same volume. If partition id is 2 or higher, as indicated in the partition table, then the blob data resides on a secondary partition. Secondary partitions are the data partitions that will receive the redirected 712 data.

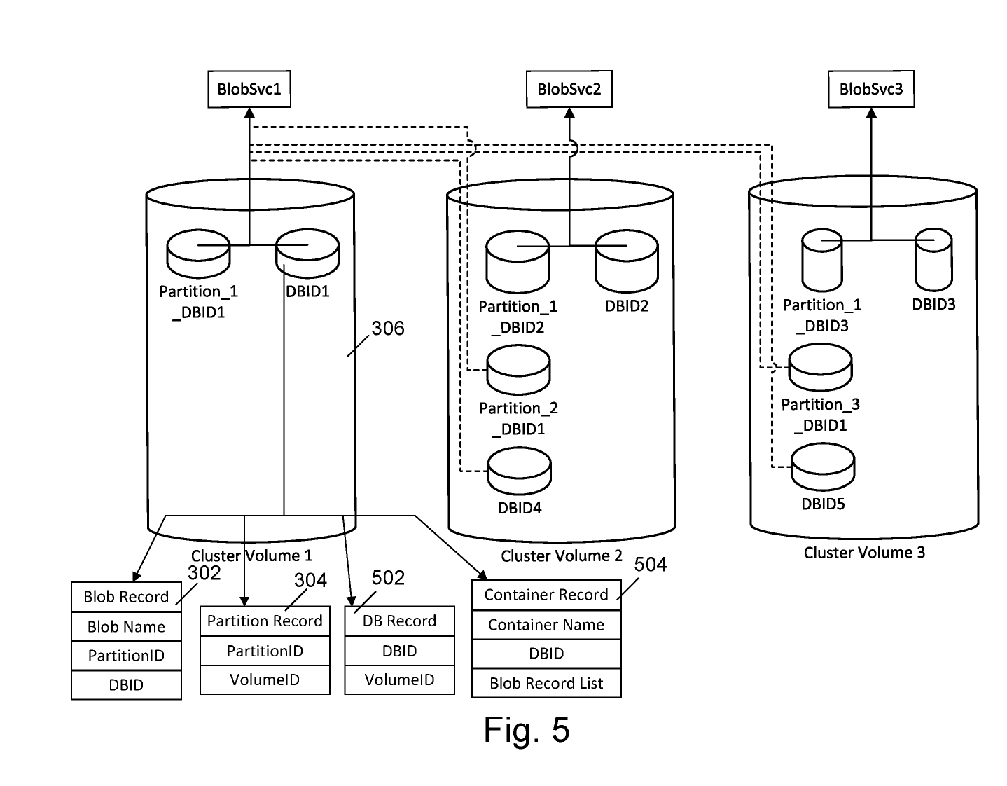

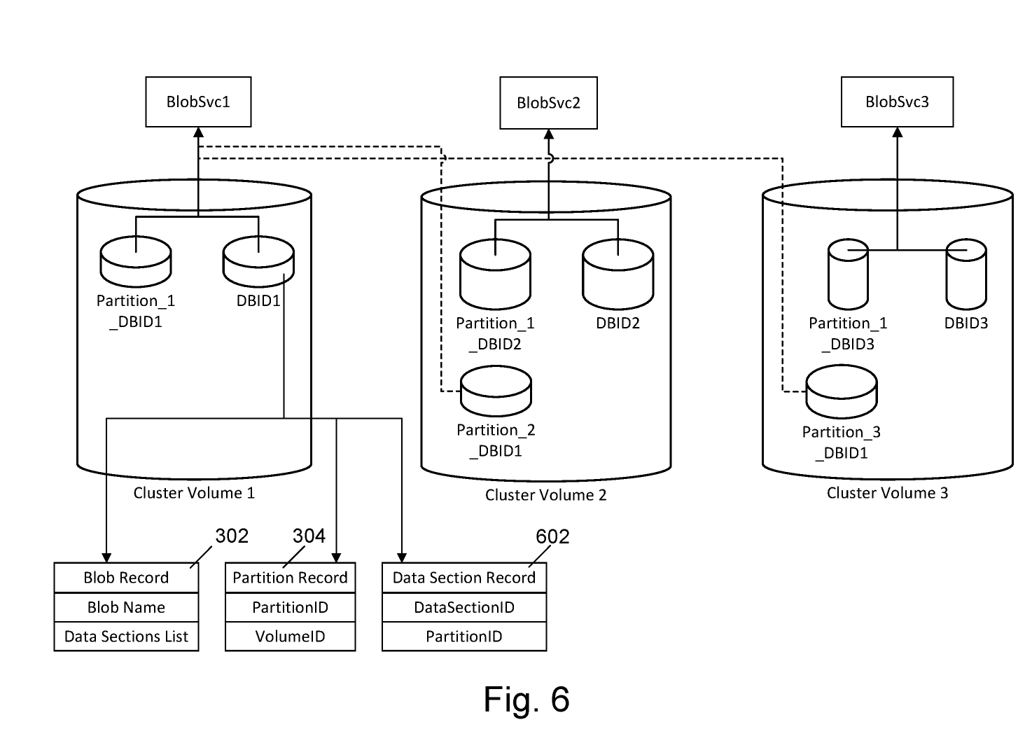

In provisional U.S. patent application No. 62/463,663 filed 1 Mar. 2017, which is incorporated herein by reference and to which priority is claimed, FIGS. 3, 5, and 6 illustrated databases and corresponding partitions using color as well as using numeric indicators in identifiers. For instance, FIG. 3 shows in red database DBID1 and its partitions Partition_1_DBID1, Partition_2_DBID1, and Partition_3_DBID1; FIG. 3 shows in green database DBID2 and its partitions Partition_1_DBID2, Partition_2_DBID2, and Partition_3_DBID2; and FIG. 3 shows in orange database DBID3 and its partitions Partition_1_DBID3, Partition_2_DBID3, and Partition_3_DBID3. Color is similarly used in FIGS. 5 and 6 of the provisional application. To comply with drawing requirements for non-provisional patent applications, color is not used in the Figures of the present non-provisional patent application. Instead, combinations of relative diameter and relative height are used, along with the numeric indicators in identifiers. Thus, the DBID2 items illustrated are relatively taller than the DBID1 items shown, and the DBID3 items illustrated are both relatively taller and relatively smaller in diameter than the DBID1 items shown. These visual differences are merely for convenient reinforcement of the distinctions already made with the numeric indicators in identifiers, and in particular these visual differences have no bearing on the relative number of records or relative storage usage or storage capacity of the illustrated items.

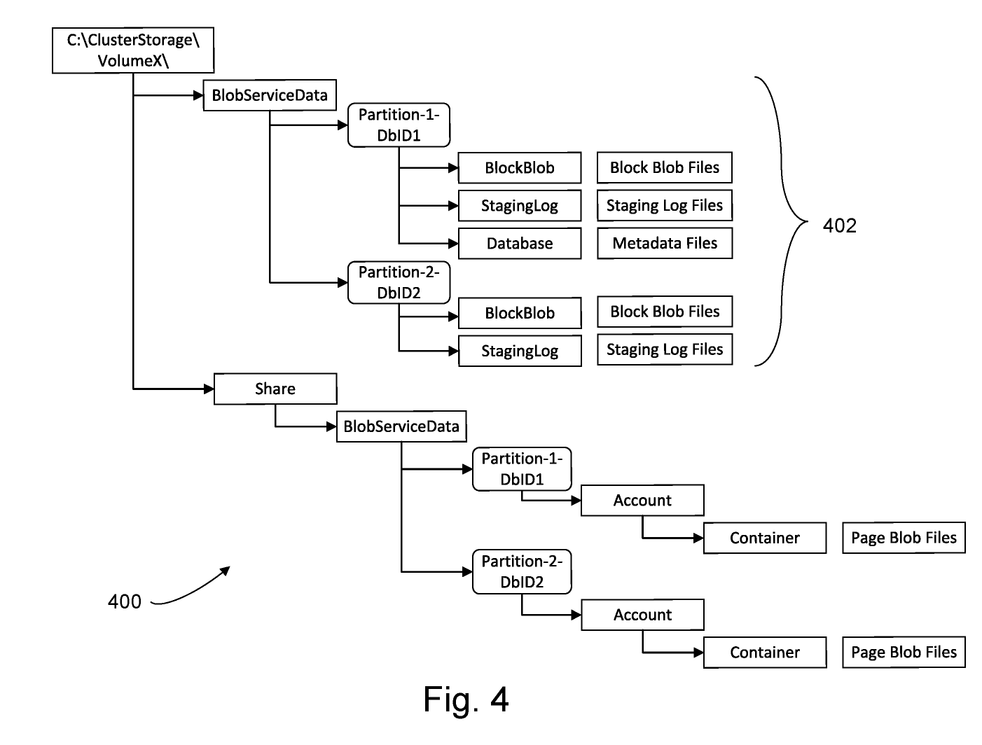

Similarly, partition identifiers shown in a green color in FIG. 4 of the provisional application are shown in FIG. 4 of the current non-provisional document without color. Corner rounding is used instead.

In some examples, discovery 736 of partitions happens at blob service startup or when a CSV volume fails over. In such cases, another cluster service, e.g., the startup service or the fail over service, will notify whichever blob service is involved, namely, whichever blob service is currently controlling implicated volumes as MDS (metadata server, a.k.a. metadata owner). The MDS is the primary owner node of the clustered shared volume. Only one node in a cluster is the designated MDS (metadata owner) for a given CSV at a given time. When the blob service receives 738 this notification 740, it will first try to open 744 the DB (metastore 228) at a well-known fixed location for that volume. For example, in the FIG. 4 diagram, the path will be: c:\ClusterStorage\VolumenBlobServiceData\Partition-1-DBID1\DataBase. (This path is presented only as an example within the present disclosure, not as executable code; please refer to Note Regarding Hyperlinks herein.) Once the DB is opened, the partition table is opened and used 746. This will give the list of all data partitions for that volume and their paths. For instance, in the FIG. 3 example, when Cluster Volume 2 DB is opened, the service will discover a secondary data partition Partition-2-DBID2 that exists on Cluster Volume 1.

Namespace Mapping

Some embodiments map 748 a flat namespace 750 to file system artifacts 752 (files, objects, or other artifacts) in a clustered file system 214. In some cases, an object in a container can be universally identified in a uniform flat name space using an identifier such as a URL. As an example, the URL may be http://www.myaccount.com/container1/sample.blob. (This URL is presented only as an example within the present disclosure, not as executable code; please refer to Note Regarding Hyperlinks herein.) In FIG. 4, the diagram illustrates a mapping data structure 400, and hence a method, to map 748 container objects from a flat namespace to a specific location under a partition on a clustered file system (e.g., in a CSV). The upper branch 402 shows additional file system artifacts the service creates that may be relevant for individual pieces of each object.

MetaData Overflow

Some embodiments cover overflow 716 of the metadata 222 of such object containers 218. In some cases, metadata overflow could be avoided by redirecting partial blob metadata to another Metastore DB on the same volume or another CSV volume depending on whether the Metastore DB size reaches a specified 720 high watermark size 722 or the volume is running out 708 of space 710. For instance, in the diagram of FIG. 5, Cluster volume 1 has overflown both its data (by overflow 712 action) and its metadata (by overflow 716 action) to Cluster Volumes 2 and 3. In this example, the primary data partition is Partition-1-DBID1 and the primary metadata partition is DBID1. The secondary data partitions are Partition-2-DBID1 and Partition-3-DBID1 while the secondary metadata partitions are DBID4 and DBID5.

Overflowing A Very Large Object

Consider the case of a one “large” blob object, e.g., a 1 terabyte or larger object that, depending on system details, may not fit as a whole in a remaining free space in a given CSV. In some embodiments, an object service 212 can split 754 the object into multiple parts referred to herein as “sections” 238. These sections are then stored 714 in local and remote partitions 216 while the metadata associated with the object and the primary section(s) of the object are kept 718, 732 in the original CSV volume.

An example metadata schema is illustrated in FIG. 6. In the example diagram of FIG. 6, a blob record is divided into two sections. One data section is located in Partition_2_DBID1 and the other section is in Partition_3_DBID1.

Migration

One or more of the overflow actions 712 (overflow data objects of a container), 714 (overflow data of an individual relatively large object), 716 (overflow metadata of objects of a container or of the container itself) discussed herein may also be reversed by migration 758 actions which bring an object's data or metadata or both back to the object's primary volume after storage space has become available on that primary volume. Migration 758 may also or alternately move an object to another CSV volume, and may even change the primary volume definition. This also holds true for migrating the container of objects. Migration may be automatically initiated, e.g., in response to polling or notice that determines sufficient space is now available on the primary partition. In some examples, migration may also be initiated manually by an administrator, using a API or other interface to the object service.

Configured Media

Some embodiments include a configured computer-readable storage medium 112. Medium 112 may include disks (magnetic, optical, or otherwise), RAM, EEPROMS or other ROMs, and/or other configurable memory, including in particular computer-readable media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as object service software 212, a metastore 228, and overflow thresholds 722, in the form of data 118 and instructions 116, read from a removable medium 114 and/or another source such as a network connection, to form a configured medium. The configured medium 112 is capable of causing a computer system to perform technical process steps for reallocating scarce capacity as disclosed herein. The Figures thus help illustrate configured storage media embodiments and process embodiments, as well as system and process embodiments. In particular, any of the process steps illustrated in FIG. 7 or otherwise taught herein, may be used to help configure a storage medium to form a configured medium embodiment.

Some Additional Combinations and Variations

Some examples provide methods and mechanisms to overflow the data and metadata of object containers on multiple clustered shared volumes in a distributed system. Some examples provide methods and mechanisms to map a flat namespace operating as an object namespace to a single clustered shared volume, yet overflow such containers as needed without breaking the uniform namespace. Some examples cover any kind of objects, including but not limited to page objects (e.g., page blob objects in Microsoft Azure® environments), block objects (e.g., block blob objects in Microsoft Azure® environments), and blob objects implemented in an object service. Azure® is a mark of Microsoft Corporation. Some examples provide methods and mechanisms to overflow a large object itself over multiple volumes, by breaking the data to smaller pieces (referred to here as “sections” but other names may be used) and spreading those pieces across multiple partitions, while keeping the large object's metadata in one volume or one partition. In other cases, both the sections and the metadata of the large object are overflowed.

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the medium combinations and variants describe above.

### Additional Example #1

This example includes a computing technology method for scalable object service overflow in a cloud computing environment (100) having computational resources (110, 112, 130) which support instances of computing services (124), the method including: identifying (726) a storage capacity deficiency in a cluster volume X (210); designating (730) a cluster volume Y to receive overflow from a container (218) whose primary volume is cluster volume X; and overflowing (712, 714, 716) at least one of the following items from cluster volume X to cluster volume Y: (a) individual data objects (220) of the container, namely, data objects which are contained by the container, (b) at least one section (238) of a data object of the container, the data object having data (240), the section containing a portion but not all of the data of the data object, (c) metadata (222) of at least one object of the container, or (d) system metadata (222) of the container.

### Additional Example #2

The method of Additional Example #1, further including at least partially reversing the overflowing by migrating (758) overflowed data or overflowed metadata or both back to cluster volume X.

### Additional Example #3

The method of Additional Example #1, further including migrating (758) at least a portion of overflowed data or overflowed metadata or both to a newly designated cluster volume Z.

### Additional Example #4

The method of Additional Example #1, further including specifying (720) an overflow threshold (722) which the identifying is at least partially based on.

### Additional Example #5

The method of Additional Example #1, further including mapping (748) an identifier (242) in a namespace (750) which hides the overflow to an expanded identifier (242) which includes at least the identity of cluster volume Y.

### Additional Example #6

The method of Additional Example #1, wherein the method overflows (714) data of a binary large object, or overflows (716) metadata associated with a binary large object, or does both.

### Additional Example #7

The method of Additional Example #1, wherein the method overflows (712) from cluster volume X at least some object data (240) of at least one object (220) of the container but keeps (718) all system metadata of the container on cluster volume X.

### Additional Example #8

The method of Additional Example #1, wherein the method operates (712 or 714) on data objects which include binary large objects, and the method operates in a public cloud computing environment.

### Additional Example #9

A system including: a cluster (200) which has a cluster volume X (210) and a cluster volume Y (210); a container (218) whose primary volume is cluster volume X, the container having metadata (222) and containing at least one data object (220); at least one processor (110); a memory (112) in operable communication with the processor; and object storage management software (212) residing in the memory and executable with the processor to overflow (712, 714, or 716) at least one of the following items from cluster volume X to cluster volume Y: (a) multiple individual data objects of the container, namely, data objects which are contained by the container, (b) at least one section (238) of a data object of the container, the data object having data, the section containing a portion but not all of the data of the data object, (c) metadata of at least one object of the container, or (d) system metadata of the container.

### Additional Example #10

The system of Additional Example #9, wherein the object storage management software includes a container table (236) which lists all containers allocated in cluster volume X.

### Additional Example #11

The system of Additional Example #9, wherein the object storage management software includes and manages metadata, and the metadata includes a list of data sections (238) of a data object, a first data section of the data object is stored on a first cluster volume, and a second data section of the same data object is stored on a second cluster volume.

### Additional Example #12

The system of Additional Example #9, wherein at least two objects (220) of the container are stored on different cluster volumes than one another, and wherein the object storage management software includes a metadata database (228) that keeps track of which cluster volume (306) holds a given data object of the container.

### Additional Example #13

The system of Additional Example #9, wherein at least two metadata records (302, 304, or 602) of the container are stored on different cluster volumes than one another, and wherein the object storage management software keeps track of which cluster volume holds a given metadata record of the container. For example, after a metadata overflow, the primary database on the primary volume contains information specifying the location of the overflowed metadata in another partition on another volume.

### Additional Example #14

The system of Additional Example #9, wherein the object storage management software manages metadata (222) which satisfies at least four of the following conditions: the metadata includes a blob record (302) having a blob name, the metadata includes a blob record (302) having a partition ID, the metadata includes a blob record (302) having a data sections list, the metadata includes a partition record (304) having a partition ID, the metadata includes a partition record (304) having a volume ID, the metadata includes a data section record (602) having a data section ID, the metadata includes a data section record (602) having a partition ID, the metadata includes a DB record (502) having a partition ID which aids tracking which cluster volume holds a given metadata record of the container, the metadata includes a DB record (502) having a DB ID (a.k.a. DBID) which aids tracking which cluster volume holds a given metadata record of the container, the metadata includes a DB record (502) having a volume ID, the metadata includes a container record (504) having a DB ID, the metadata includes a container record having a blob record list, the metadata includes any of the foregoing involving an object record for a non-blob object in place of the blob record.

### Additional Example #15

The system of Additional Example #14, wherein the object storage management software manages metadata which satisfies at least six of the conditions.

### Additional Example #16

A computer-readable storage medium (114) configured with executable instructions (116) to perform a computing technology method for scalable object service overflow in a cloud computing environment (100) having computational resources which support instances of computing services, the method including: identifying (726) a storage capacity deficiency in a cluster volume X; designating (730) a cluster volume Y to receive overflow from a container whose primary volume is cluster volume X; and overflowing (712, 714, or 716) at least two of the following items from cluster volume X to cluster volume Y: (a) individual data objects of the container, namely, data objects which are contained by the container, (b) at least one section of a data object of the container, the data object having data, the section containing a portion but not all of the data of the data object, (c) metadata of at least one object of the container, or (d) system metadata of the container.

### Additional Example #17

The computer-readable storage medium of Additional Example #16, wherein the method overflows at least three of the items (a), (b), (c), or (d).

### Additional Example #18

The computer-readable storage medium of Additional Example #16, further including at least one of the following: migrating (758) at least a portion of overflowed data back to cluster volume X, migrating (758) at least a portion of overflowed metadata back to cluster volume X, migrating (758) at least a portion of overflowed data to a cluster volume Z, or migrating (758) at least a portion of overflowed metadata to a cluster volume Z.

### Additional Example #19

The computer-readable storage medium of Additional Example #16, further including mapping (748) an identifier in a namespace (750) which hides the presence of any overflow to cluster volume Y to an expanded identifier which includes at least the identity of cluster volume Y.

### Additional Example #20

The computer-readable storage medium of Additional Example #16, further including splitting (754) into at least two data sections (238) a data object (220) which has at least one terabyte of data (240), and overflowing (714) at least one of the data sections, whereby the data of the data object is stored on at least two cluster volumes.

### Additional Example #21

Assume that a BlobSvc1 has a primary VolumeId1 that has a metastore DBId1 and a datastore PartitionId1. Assume that VolumeId1 is almost full and is using VolumeId2 as its overflow destination so that it has part of its metastore in DBId2 and part of its datastore in PartitionId2. Then adding a blob may proceed as follows, assuming that a container table has “Container1” in the DBId1 and has its DBId field set to DBId1 because it is located on VolumeId1. A client would like to insert “Blob1” into “Container1” but VolumeId1 is now redirecting blob creation to VolumeId2 and will not have that blob metadata inserted in its DBId1 or its data partition PartitionId1. Therefore, once BlobSvc1 receives the request, it will insert a blob record into BlobRecordList of “Container1” in DBID1 that only has the name “Blob1” and DBId set to DBID2. In DBID2, a container table will exist that has “Container1” and the BlobSvc1 will insert a record in the Blob Record List of Container1 with all the metadata related to this blob. One of the metadata fields is the PartitionId which will be set to PartitionId2.

### Additional Example #22

As in Additional Example #21, assume that a BlobSvc1 has a primary VolumeId1 that has a metastore DBId1 and a datastore PartitionId1. Assume that VolumeId1 is almost full and is using VolumeId2 as its overflow destination so that it has part of its metastore in DBId2 and part of its datastore in PartitionId2. Then adding a container may proceed as follows, assuming that there is a request to create “Container2” received by BlobSvc1. The BlobSvc1 will insert a record for “Container2” in the container table in DBId1 which will have DBId field filled with DBId2. The BlobSvc1 will then insert another record for “Container2” in the container table in DBId2. Now any new blob insertion coming to BlobSvc1 for “Container2” will first lookup the container location and will find that it is DBId2. Therefore, BlobSvc1 will then insert the blob record into the Blob Record List of “Container2” in DBId2.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 7 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific APIs, specific fields, and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing technology method for scalable object service overflow in a cloud computing environment having computational resources which support instances of computing services, the method comprising:
identifying a storage capacity deficiency in a cluster volume X;
designating a cluster volume Y to receive overflow from a container whose primary volume is cluster volume X; and
overflowing at least one of the following items from cluster volume X to cluster volume Y: (a) individual data objects of the container, namely, data objects which are contained by the container, (b) at least one section of a data object of the container, the data object having data, the section containing a portion but not all of the data of the data object, (c) metadata of at least one object of the container, or (d) system metadata of the container.

2. The method of claim 1, further comprising at least partially reversing the overflowing by migrating overflowed data or overflowed metadata or both back to cluster volume X.

3. The method of claim 1, further comprising migrating at least a portion of overflowed data or overflowed metadata or both to a cluster volume Z.

4. The method of claim 1, further comprising specifying an overflow threshold which the identifying is at least partially based on.

5. The method of claim 1, further comprising mapping an identifier in a namespace which hides the overflow to an expanded identifier which includes at least the identity of cluster volume Y.

6. The method of claim 1, wherein the method overflows data of a binary large object, or overflows metadata associated with a binary large object, or does both.

7. The method of claim 1, wherein the method overflows from cluster volume X at least some object data of at least one object of the container but keeps all system metadata of the container on cluster volume X.

8. The method of claim 1, wherein the method operates on data objects which include binary large objects, and the method operates in a public cloud computing environment.

9. A system comprising:
a cluster which has a cluster volume X and a cluster volume Y;
a container whose primary volume is cluster volume X, the container having metadata and containing at least one data object;
at least one processor;
a memory in operable communication with the processor; and
object storage management software residing in the memory and executable with the processor to overflow at least one of the following items from cluster volume X to cluster volume Y: (a) multiple individual data objects of the container, namely, data objects which are contained by the container, (b) at least one section of a data object of the container, the data object having data, the section containing a portion but not all of the data of the data object, (c) metadata of at least one object of the container, or (d) system metadata of the container.

10. The system of claim 9, wherein the object storage management software comprises a container table which lists all containers allocated in cluster volume X.

11. The system of claim 9, wherein the object storage management software includes and manages metadata, and the metadata comprises a list of data sections of a data object, a first data section of the data object is stored on a first cluster volume, and a second data section of the same data object is stored on a second cluster volume.

12. The system of claim 9, wherein at least two objects of the container are stored on different cluster volumes than one another, and wherein the object storage management software comprises a metadata database that keeps track of which cluster volume holds a given data object of the container.

13. The system of claim 9, wherein at least two metadata records of the container are stored on different cluster volumes than one another, and wherein the object storage management software keeps track of which cluster volume holds a given metadata record of the container.

14. The system of claim 9, wherein the object storage management software manages metadata which satisfies at least four of the following conditions: the metadata includes a blob record having a blob name, the metadata includes a blob record having a partition ID, the metadata includes a blob record having a data sections list, the metadata includes a partition record having a partition ID, the metadata includes a partition record having a volume ID, the metadata includes a data section record having a data section ID, the metadata includes a data section record having a partition ID, the metadata includes a DB record having a partition ID, the metadata includes a DB record having a DB ID.

15. The system of claim 14, wherein the object storage management software manages metadata which satisfies at least six of the conditions.

16. A computer-readable storage medium configured with executable instructions to perform a computing technology method for scalable object service overflow in a cloud computing environment having computational resources which support instances of computing services, the method comprising:
identifying a storage capacity deficiency in a cluster volume X;
designating a cluster volume Y to receive overflow from a container whose primary volume is cluster volume X; and
overflowing at least two of the following items from cluster volume X to cluster volume Y: (a) individual data objects of the container, namely, data objects which are contained by the container, (b) at least one section of a data object of the container, the data object having data, the section containing a portion but not all of the data of the data object, (c) metadata of at least one object of the container, or (d) system metadata of the container.

17. The computer-readable storage medium of claim 16, wherein the method overflows at least three of the items (a), (b), (c), or (d).

18. The computer-readable storage medium of claim 16, further comprising at least one of the following: migrating at least a portion of overflowed data back to cluster volume X, migrating at least a portion of overflowed metadata back to cluster volume X, migrating at least a portion of overflowed data to a cluster volume Z, or migrating at least a portion of overflowed metadata to a cluster volume Z.

19. The computer-readable storage medium of claim 16, further comprising mapping an identifier in a namespace which hides the presence of any overflow to cluster volume Y to an expanded identifier which includes at least the identity of cluster volume Y.

20. The computer-readable storage medium of claim 16, further comprising splitting into at least two data sections a data object which has at least one terabyte of data, and overflowing at least one of the data sections, whereby the data of the data object is stored on at least two cluster volumes.
